(19) United States
(12) Patent Application Publication
(10) Pub. No.: US 2012/0136957 A1
(43) Pub. Date: May 31, 2012

(54) PORTABLE CLIENT AND SERVER PLATFORM

(75) Inventors: Samuel W. Bellamy, III, Bryn Mawr, PA (US); Christopher R. Kronenthal, Penn Valley, PA (US)

(73) Assignee: FreedomPay Inc., Radnor, PA (US)

(21) Appl. No.: 13/350,820

(22) Filed: Jan. 16, 2012

Related U.S. Application Data
(60) Provisional application No. 61/560,791, filed on Nov. 16, 2011.
(60) Provisional application No. 61/560,797, filed on Nov. 16, 2011.

(51) Int. Cl. G06F 15/16

(52) U.S. Cl. 709/208

(57) ABSTRACT

A portable client and server platform system is disclosed. The present system provides the abstraction of host applications in a master host platform from clients and hosts. The abstraction allows for unique scalability and cross-platform designs for large enterprise applications. The present system allows the download of a single client application onto a client to provide expansive user functionality. The functionality of the single client application is common yet specific to requirements of the operating systems, firmware, drivers, and hardware of the clients. This architectural approach abstracts the client platforms from the host applications of the master host platform. The present system has server-side application logic and switching capabilities in the master host platform; thus, the host applications are capable of remotely controlling various client platform resources for presentation of software applications onto remote clients.

### CROSS REFERENCE TO RELATED APPLICATIONS

This application claims benefit from U.S. Provisional Patent Applications Nos. 61/560,791 and 61/560,797 filed on Nov. 16, 2011, which are hereby incorporated by reference.

### FIELD OF THE INVENTION

The present invention relates to client-server architectures, in particular to systems which have application logic and switching capabilities from server-sides or host applications.

### BACKGROUND OF THE INVENTION

In providing Platform as a Service (PaaS) and Software as a Service (SaaS) as solutions for electronic transactions, a gateway is a critical component of the architecture having capability of translating protocols and data formats for intercommunications of disparate data information systems. And, a rules engine integrates tightly with the gateway and provides rules validation at the field or column level individually or with a grouping of compound rules. The present invention, a portable client and server platform system, is a unique and powerful platform which leverages the capabilities of the gateway and the rules engine to transact with client devices. The present system is similar to traditional client-server architectures. However, the present system has server-side application logic and switching capabilities in a master host platform; thus, host applications in a master host platform are capable of remotely controlling various client platform resources for presentation of software applications onto remote client devices.

Today, mobile client applications tend to be relatively monofunctional, i.e., they are designed for a singular presentation and a singular functionality. The present systems allows for dynamic and innovative enterprise-wide applications on the basis of real-time parameters on various supporting client platforms such as mobile phones, tablets, point-of-sale terminals, personal computers, and GPS devices.

In the present invention, the development of a single client application is capable for the presentation and functionality of software applications across platforms of client devices. In the present invention, the download of a single client application is capable of providing expansive user functionality. However, traditional client applications do not have these capabilities.

Distinguished from traditional systems, in the present invention, host applications are abstracted from clients through controllers in the master host platform, and host applications are abstracted from hosts, which include transaction destination hosts and repositories, through connectors in the master host platform. The abstractions allow the host applications to function on multiple and varied client platforms with support from the multiple and varied controllers and to function on multiple and varied host platforms with support from the multiple and varied connectors. This furnishes scalability and cross-platform designs for large enterprise applications. The segregation and combination of the controllers, the host applications, and the connectors provides a platform capable of significantly larger and more complex enterprise solutions.

### SUMMARY OF THE INVENTION

The present invention discloses a portable client and server platform system. The system allows application logic, validation, workflow, and presentation layer control at a server or a master host platform. The master host platform manages application logic, workflow, and select resources such as screens, themes, skins, and certificates at client devices, and master host platform supports thin-client operation on client devices. Examples of the client devices are mobile phones, tablets, personal computers, and PCI PED compliant terminals, and any similar client hardware that has operating systems and firmware. Thus, the present system allows for the development of a single client application for the presentation and functionality of software applications across many hardware and software platforms of client devices. The server or master host platform manages the single client application on the client devices through a light messaging protocol such as Representational State Transfer (REST) and a short message command set. The client devices receive commands sent from the server or the master host platform using the light messaging protocol and interpret contents of the commands to manage the input and output (I/O) communications for screens, keyboards, audio, radio, motion sensors, GPS, UBS, HDMI, and other resources on the client devices. The additional utilization of daemons at the client devices allows for push of private messaging and enables functional commands to remotely control the client devices as appropriate. For example, the server or the master host platform may send a secure command to the client devices to activate Bluetooth, WiFi, or GPS without user's intervention. The client devices first retrieve resources locally. If the resources are not present locally, the client devices request the resources from the master host platform and cache locally, as appropriate. The master host platform may redirect application functionality to another host application for functionality. On the basis of select user selection or the master host platform logic, the master host platform redirect the client devices to other host applications as separate calls or through thread management. The present system allows the download of a single client application to provide expansive user functionality. With centralized management, functional enhancements occur through a controlled release process in the master host platform without any requirement of downloading newer versions to the client devices. Thus, the present invention allows for a greater level-of-quality in a more timely manner.

The present invention has the following advantages:

(1) The present system allows for more secure and much greater control and functionality through a single client application.

(2) A single client application presents myriad significant increases in functionality without the needs to manage several applications and downloadable upgrades.

(3) The present invention improves service levels for mobile users because of reduction in the overhead in mobile application downloads.

(4) In the present invention, version control management for each of multiple mobile applications on a mobile client device is no longer needed.

(5) In the present invention, consumer downloads in order to achieve latest versions and bug-fixes are no longer needed.

(6) The host-client architecture in the present invention enables larger enterprise solutions through a single client application on mobile devices.

(7) In the present invention, there is no need to manage distributions across hardware and software platforms because all functionality and branding are available at the master host platform.

(8) In the present invention, greater functionality is available in comparison to current mobile application architectures.

(9) In the present invention, there is less demand on client resources since only those resources (such as data, screens, logic) frequently used are cached on client devices.

(10) In the present invention, bandwidth requirements are less over wireless networks, thus resulting in lower consumer/user costs.

The portable client and server platform system comprises at least one master host platform, at least one gateway, at least one rules engine, a plurality of clients, a plurality of hosts which comprise transaction destination processors and repositories. The at least one master host platform comprises a plurality of host applications, a plurality of controllers, and plurality of controllers. The respective host applications, the respective controllers, and the respective connectors reside on a plurality of servers which are hosted by at least one physical or virtual computing machine. The plurality of clients comprise point-of-sale devices, Web services of electronic commerce, and mobile devices. The hosts comprise payment processing hosts, custom application branding, incentives, geographic fencing, data warehousing, enterprise resource planning, and market database service. The incentives comprise loyalty, vouchers, coupons, and promotion. The payment processing hosts comprise third party processors, stored value processors, payment processors, card associations, issuing banks, and acquiring banks.

The gateway is a transaction gateway capable of passing any transaction data in multiple levels of hierarchy. The gateway functions in the conversion of data mapping from one format to another and conversion of messaging protocols. Through the connectors, the master host platform invokes, manages, and controls custom operations of the gateway. The gateway is a common interface of transactions between the clients and the hosts.

The rules engine is tightly integrated with the gateway, and it is for the application of data validation upon input and exit on the basis of interrelationships at the field or column level and specific field/column level validation. Through the connectors, the master host platform manages, and controls custom operations of the rules engine.

The master host platform provisions the integral function of communications from the clients to the hosts. The communications between the respective clients and the respective host applications in the master host platform are through the respective controllers which are in master host platform. The respective host applications in the master host platform communicate with each other. The communications between the respective hosts and the respective host applications are through the respective connectors. On an occasion when the gateway is invoked by the master host platform, the communications between the gateway and the respective host applications in the master host platform are through the respective connectors. On an occasion when the rules engine is invoked by the master host platform, the communications between the rules engine and the respective host applications are through the respective connectors. The gateway and the rules engine communicate with each other when both the gateway and the rules engine are invoked by the master host platform. On an occasion when the gateway is invoked by the master host platform, the gateway communicates with the respective hosts.

The master host platform has a host application that remotely manages the respective clients by sending commands thereto through the respective controllers. Within each of the clients there resides a thin client application for managing resources locally on the each of the clients and communications with the host applications in the master host platform through controllers. The functionality of the thin client application is common yet specific to requirements of the operating systems, firmware, drivers, and hardware of the clients. This architectural approach abstracts the client platforms from the applications residing in the host applications of the master host platform.

The thin client application runs in a foreground or in a background as a daemon application communicating with the master host platform. The thin client application accepts messages from a specific controller and acts accordingly upon the request sent from the master host platform. Services provided by the thin client application include but are not limited to:

(1) The thin client application receives and interprets commands sent from the master host platform.

(2) The thin client application converts the commands as necessary and direct the clients to function accordingly.

(3) The thin client application acts as a primary form of communications with the master host platform.

(4) The thin client application manages input and output (I/O) for the local resources and data storage.

(5) The thin client application presents the host applications of the master host platform onto the clients.

The respective controllers, the respective host applications, and the respective connectors may reside on a plurality of respective servers hosted by an individual or multiple physical or virtual machines. Intercommunications among the respective servers may occur through an optimized and generally open platform communication interface, such as Extensible Markup Language (XML), Web service calls, Application Programming Interface (API), and Software Development Kit (SDK). In a virtualized environment, the segregation and combination of the respective controllers, the respective applications, and the respective connectors provide a platform capable of being significantly larger and supportive of more complex enterprise solutions.

The master host platform, through respective controllers, send the commands using a light messaging protocol, such as Representational State Transfer (REST) and a short message command set. The master host platform sends commands and requests to the respective clients as light-weight messages within a custom string subset. Within the thin client application, there resides a parser-interpreter which segments the commands and converts the commands and requests to actionable steps specific to the respective clients. The utility of the combination of the light messaging protocol and the parser-interpreter enables very powerful and complex applications to reside on a mobile platform of limited resources as never before.

The respective host applications communicate with the respective clients through the respective controllers. The respective controllers comprise unique subsystems for different client platforms as necessary. When application functionality extends to new client platforms, new controller subsystems provide operations with the respective clients allowing application functionality to function across the new client platforms. Communications between the respective host applications and the respective controllers may occur through any of Extensible Markup Language (XML), Web-service calls, Application Programming Interface (API), and Software Development Kits (SDK), where API or SDK generally supports direct calls through dynamic link libraries (DDL) or services.

The master host platform recognizes the need for control, managed release, maintenance, and inter-operation among the host applications. The unique application and enterprise application functionality resides within the respective host applications. All logic and workflow reside within state machines of the respective host applications. The master host platform supports aggregation of application support across an enterprise through the interoperability of operational parameters among threaded or stand-alone applications. The interfaces to the state machines of the host applications occurs through Extensible Markup Language (XML), Web service calls, Application Programming Interface (API), Software Development Kit (SDK), or scripting languages. The scripting languages allow for function enhancements for future demand. A scripted language application residing in the master host platform may implement various state machines of the host applications as necessary to provide given functionality for the clients.

The respective host applications communicate with the respective hosts through the respective connectors. Connector subsystems support operational functionality with the respective hosts as necessary. This architecture supports a single and common instance of host support with extensibility across multiple platforms of the hosts. As demand for new functionality of the hosts occurs, new connector subsystems may extend operability.

The respective host applications communicate with the respective connectors in a similar manner that the respective host applications communicate with the respective controllers, including but not limited to: Extensible Markup Language (XML), Web-service calls, application programming interface (API), and software development kit (SDK). Commands and requests originated from the respective host applications pass to the respective connectors for specific conversion to the platforms of the hosts.

The present system provides the abstraction of the respective host applications from the respective clients through the respective controllers, and also the abstraction of the respective host applications from the hosts through the respective connectors. The abstractions allow for a common host application to function on various platforms of the respective clients and various platforms of the respective hosts. The present system provisions unique scalability and cross-platform designs for large enterprise applications.

Upon demand the gateway is invoked by the master host platform and it is an transaction gateway to the respective hosts. The respective host applications communicate with the gateway through the respective connectors. The communications between the respective connectors and the gateway uses Extensible Markup Language (XML), Web-service calls, application programming interface (API), or software development kit (SDK).

The present system supports application of the presentation, activation, redemption, and validation of certain mobile user incentives and discounts in forms which comprise electronic coupons, immediate discounts, and vouchers.

The present system supports the dynamic presentations of branding when the respective host application demand. The branding comprises overall application branding, incentive branding, location branding, and time period branding.

### BRIEF DESCRIPTION OF THE DRAWINGS

FIG. 1 is a diagram showing architecture of an exemplary portable client and server platform system.

### DETAILED DESCRIPTION OF EXEMPLARY EMBODIMENTS

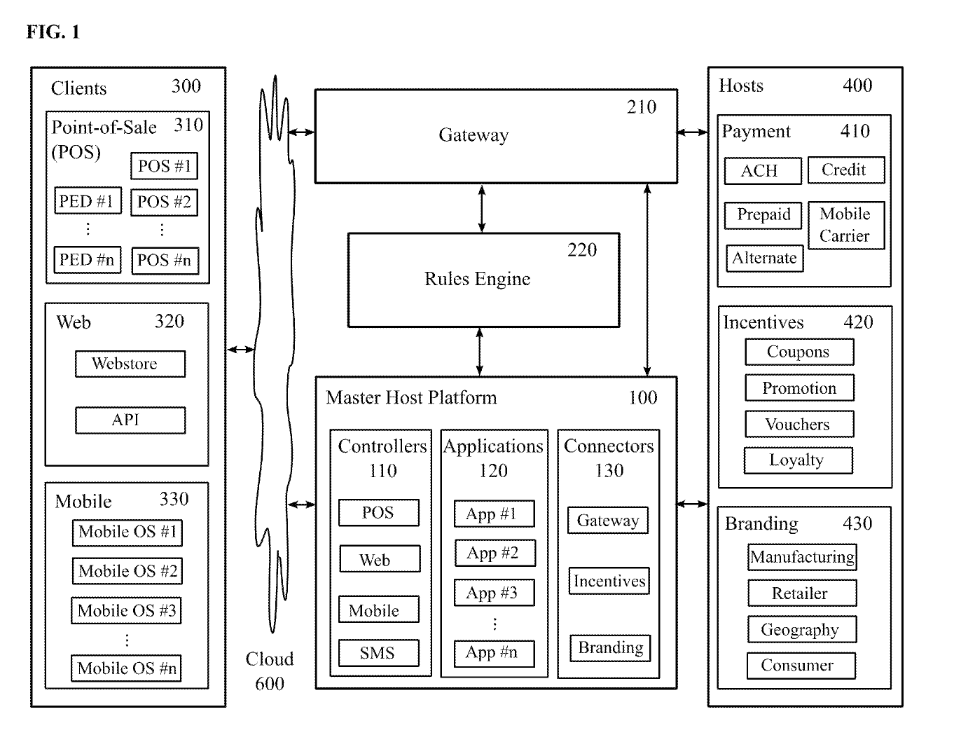

FIG. 1 shows the architecture of an exemplary portable client and server platform system. Referring to FIG. 1, the exemplary system comprises a master host platform 100, a gateway 210, a rules engine 220, a plurality of clients 300, a plurality of hosts 400 which include transaction destination processors and repositories. The plurality of clients 300 comprise a plurality of point-of-sale devices 310, a plurality of mobile devices 330, and a plurality of Web services of electronic commerce 320. The plurality of point-of-sale devices 310 include PCI compliance PED terminals. The plurality of mobile devices 330 comprise mobile phones, tablets, personal computers, and GPS devices. The plurality of mobile devices 330 use different mobile operating systems. The plurality of hosts 400, which are transaction destination processors and repositories, comprise a plurality of payment processing hosts 410, a plurality of incentives hosts 420, and a plurality of branding hosts 430. The plurality of payment processing hosts 410 comprise third party processors, stored value processors, payment processors, card associations, issuing banks, and acquiring banks. The plurality of incentives hosts 420 comprise loyalty, vouchers, coupons, and promotion. Interfaces with the respective incentives hosts 420 support application of the presentation, activation, redemption, and validation of certain mobile user incentives and discounts in forms which comprise electronic coupons, immediate discounts, and vouchers. The plurality of branding hosts 430 comprise manufacturing branding, retailer branding, geography branding, and consumer branding. Interfaces with the respective branding hosts 430 support the dynamic presentations of branding when the respective host applications demand. The gateway 210 is a transaction gateway which is invoked, managed, and controlled by the master host platform 100. The rules engine 220 is tightly integrated with the gateway 210 and it is for data validation. The rules engine 220 is invoked, managed, and controlled by the master host platform 100.

The master host platform 100 comprises a plurality of controllers 110, a plurality of host applications 120, and a plurality of connectors 130. The respective controllers 110, the respective host applications 120, and the respective connectors 130 may reside on a plurality of servers which are hosted by an individual or multiple physical or virtual computing machines. Intercommunications among the servers are through Extensible Markup Language (XML), Web service calls, Application Programming Interface (API), or Software Development Kit (SDK).

The respective clients 300 communicate with respective host applications 120 in the master host platform 100 through the respective controllers 110. The respective controllers 110 comprise unique subsystems for different platforms of the clients 300 as necessary. The respective hosts 400 communicate with respective host applications 120 in the master host platform 100 through the respective connectors 130. The respective connectors 130 comprise unique subsystems to support operational functionality with the respective hosts 400 as necessary. The respective connectors 130 support communications between respective host applications 120 and various hosts including payment processing hosts 410, incentives hosts 420, and branding hosts 430. When the gateway 210 is invoked by the master host platform 100, the communications between the gateway 210 and the respective host applications 120 are through the respective connectors 130. When the gateway 210 is invoked by the master host platform 100, the gateway 210 communicates with the respective hosts 400. When the rules engine 220 is invoked by the master host platform 100, the communications between the rules engine 220 and the respective host applications 120 are through the respective connectors 130. When both the gateway 210 and the rules engine 220 are invoked by the master host platform 100, the gateway 210 and the rules engine 220 communicate with each other.

The respective host applications 120 communicate with the respective controllers 110, and means of the communications comprise Extensible Markup Language (XML), Web-service calls, Application Programming Interface (API), and Software Development Kits (SDK). The respective host applications 120 communicate with the respective connectors 130, and means of the communications comprise Extensible Markup Language (XML), Web-service calls, Application Programming Interface (API), and Software Development Kits (SDK). When the gateway 210 is invoked by the master host platform 100, means of the communications between the respective connectors 130 and the gateway 210 comprise Extensible Markup Language (XML), Web-service calls, Application Programming Interface (API), and Software Development Kits (SDK). When the rules engine 220 is invoked by the master host platform 100, means of the communications between the respective connectors 130 and the rules engine 220 comprise Extensible Markup Language (XML), Web-service calls, Application Programming Interface (API), and Software Development Kits (SDK).

All logic and workflow reside within state machines of the respective host applications 120. The respective host applications 120 in the master host platform 100 communicate with each other. The master host platform 100 recognizes the need for control, managed release, maintenance, and interoperation among the host applications 120. The master host platform 100 may redirect application functionality of one of the respective host applications 120 to another one of the respective host application 120 for functionality. The master host platform 100 supports aggregation of application support through the interoperability of operational parameters among threaded or stand-alone host applications 120. The interfaces to the state machines of the host applications 120 occurs through Extensible Markup Language (XML), Web service calls, Application Programming Interface (API), Software Development Kit (SDK), or scripting languages.

The master host platform 100 remotely manages the respective clients 300 by sending commands thereto, using a light messaging protocol. The light messaging protocol comprises Representational State Transfer (REST) and a short message command set. The commands from the master host platform 100 are sent to the respective clients 300 through the respective controllers 110. Each of the respective clients 300 comprises a thin client application. Within the thin client application, there resides a parser-interpreter which is used to segment the commands and convert them to actionable steps specific to the respective clients 300.

The thin client application on each of the respective clients 300 accepts messages from the master host platform 100 through the respective controllers 110 and acts accordingly. The thin client application runs in a foreground or a background as a daemon application on the respective clients 300. The thin client application on the respective clients 300 provides services which include but are not limited to as follows. The thin client application receives and interprets the commands sent from the master host platform 100. The thin client application converts the commands and directs the respective clients 300 to function. The thin client application provides communications between the each of the respective clients 300 and the master host platform 100. The thin client application manages input and output (I/O) for local resources on the each of the respective clients 300. As necessary, the thin client application presents the host applications 120 onto the each of the respective clients 300.

Although the present invention has been described in considerable detail with clear and concise language and with reference to certain preferred versions thereof including the best mode anticipated by the inventor, other versions are possible. Therefore, the spirit and scope of the invention should not be limited by the description of the preferred versions contained therein, but rather by the claims appended hereto.

What is claimed is:

1. A portable client and server platform system comprising:
at least one master host platform, at least one gateway, at least one rules engine, a plurality of clients, a plurality of hosts comprising transaction destination processors and repositories;
said at least one master host platform comprising a plurality of host applications, a plurality of controllers, and a plurality of connectors;
said plurality of host applications comprising application functionalities, logic and workflow residing within state machines of said plurality of host applications;
respective said plurality of host applications, respective said plurality of controllers, and respective said plurality of connectors residing on a plurality of respective servers hosted by one or more computing machines;
said at least one master host platform comprising a host application of remotely managing respective said plurality of clients by sending commands thereto with a light messaging protocol;
a respective one of said plurality of clients comprising a thin client application of receiving and interpreting said commands sent from said at least one master host platform, of executing said commands, of managing input and output (I/O) for resources on said respective one of said plurality of clients, of communicating with said at least one master host platform, and of presenting respective said plurality of host applications onto said respective one of said plurality of clients;
respective said plurality of host applications and respective said plurality of clients communicating through respective said plurality of controllers;
respective said plurality of host applications communicating with each other;
respective said plurality of host applications and respective said plurality of hosts communicating through respective said plurality of connectors;
respective said plurality of host applications and said at least one gateway communicating through respective said plurality of connectors when said at least one gateway is invoked by said at least one master host platform;
respective said plurality of host applications and said at least one rules engine communicating through respective said plurality of connectors when said at least one rules engine is invoked by said at least one master host platform;
said at least one gateway communicating with said at least one rules engine when both said at least one gateway and said at least one rules engine are invoked by said at least one master host platform;
said at least one gateway communicating with respective said plurality of hosts when said at least one gateway is invoked by said at least one master host platform; and
said plurality of respective servers communicating with each other.

2. The portable client and server platform system of claim 1, wherein said plurality of clients are a plurality of point-of-sale devices.

3. The portable client and server platform system of claim 1, wherein said plurality of clients are a plurality of mobile devices.

4. The portable client and server platform system of claim 1, wherein said plurality of clients are a plurality of Web services of electronic commerce.

5. The portable client and server platform system of claim 1, wherein said light messaging protocol is Representational State Transfer (REST) and a short message command set.

6. The portable client and server platform system of claim 1, wherein said thin client application comprises a parser-interpreter for segmenting said commands sent from said at least one master host platform and for converting said commands to actionable steps on said respective one of said plurality of clients.

7. The portable client and server platform system of claim 1, wherein said thin client application runs in a foreground or a background as a daemon application on said respective one of said plurality of clients.

8. The portable client and server platform system of claim 1, wherein said resources on said respective one of said plurality of clients comprise screens, physical or virtual keyboards, audio components, radio components, motion sensors, Universal Serial Bus (USB), High Definition Multimedia Interface (HDMI), Ethernet, Bluetooth, WiFi, near field communication chips, biometrics, Short Message Service (SMS), and data storage.

9. The portable client and server platform system of claim 1, wherein means of communications among said plurality of respective servers comprise Extensible Markup Language (XML), Web service calls, Application Programming Interface (API), and Software Development Kit (SDK).

10. The portable client and server platform system of claim 1, wherein means of communications between respective said plurality of controllers and respective said plurality of host applications comprise Extensible Markup Language (XML), Web service calls, Application Programming Interface (API), and Software Development Kit (SDK).

11. The portable client and server platform system of claim 1, wherein respective interfaces to respective said state machines of respective said plurality of host applications are through Extensible Markup Language (XML), Web service calls, Application Programming Interface (API), Software Development Kit (SDK), or scripting languages.

12. The portable client and server platform system of claim 1, wherein means of communications between respective said plurality of connectors and respective said plurality of host applications comprise Extensible Markup Language (XML), Web service calls, Application Programming Interface (API), and Software Development Kit (SDK).

13. The portable client and server platform system of claim 1, wherein means of communications between respective said plurality of connectors and said at least one gateway comprise Extensible Markup Language (XML), Web service calls, Application Programming Interface (API), and Software Development Kit (SDK).

14. The portable client and server platform system of claim 1, wherein means of communications between respective said plurality of connectors and said at least one rules engine comprise Extensible Markup Language (XML), Web service calls, Application Programming Interface (API), and Software Development Kit (SDK).

15. The portable client and server platform system of claim 1, wherein said plurality of hosts comprise payment processing hosts, custom application branding, incentives, geographic fencing, data warehousing, enterprise resource planning, and market database service, wherein said incentives comprise loyalty, vouchers, coupons, and promotion.

16. The portable client and server platform system of claim 1, wherein said portable client and server platform system supports presentation, activation, redemption, and validation of incentives and discounts.

17. The portable client and server platform system of claim 1, wherein said portable client and server platform system supports dynamic presentation of branding, wherein said branding comprises overall application branding, incentive branding, location branding, and time period branding.

18. The portable client and server platform system of claim 1, wherein said at least one gateway passes transaction data in multiple levels of hierarchy, converts data mapping formats, and converts messaging protocols, wherein said at least one master host platform invokes, manages, and controls custom operations of said at least one gateway.

19. The portable client and server platform system of claim 1, wherein said at least one rules engine is for data validation, wherein said at least one master host platform invokes, manages, and controls custom operations of said at least one rules engine.

20. The portable client and server platform system of claim 1, wherein said one or more computing machines are physical or virtual computing machines.
